(19) United States
(12) Patent Application Publication
(10) Pub. No.: US 2012/0016555 A1
(43) Pub. Date: Jan. 19, 2012

(54) METHOD AND SYSTEM FOR PARKING ASSIST

(76) Inventor: Maher Ghneim, Livonia, MI (US)

(21) Appl. No.: 12/838,470

(22) Filed: Jul. 18, 2010

(51) Int. Cl. B62D 15/02; G06F 19/00

(52) U.S. Cl. 701/41

(57) ABSTRACT

A parking assist method comprising the steps of capturing a rear-facing image, displaying the rear-facing image, superimposing, by way of a camera module, at least one locus line on the displayed rear-facing image, sensing a steering wheel angle change on the vehicle, extracting vehicle wheel base data from memory in the camera module, calculating, in the camera module, at least one replacement locus line in response to the change in the steering wheel angle and vehicle wheel base data, and changing the display by superimposing the at least one replacement locus line on the displayed rear-facing image in place of the at least one locus line.

### TECHNICAL FIELD

The present invention is related to parking assist systems and more particularly to display overlays in a parking assist system.

### BACKGROUND

In a conventional parking assist system, a camera attached to a rear end of a vehicle takes an image of a rear field view from the vehicle. The rear field view image is displayed to a driver of the vehicle. When a driver is backing up the vehicle, as when backing into a parking space or attempting to attach a trailer to the vehicle, the parking assist system superimposes locus lines onto the image in accordance with a steering angle of the steering wheel in order to identify a target, such as the parking spot or the trailer, for the driver.

The length of the predicted locus line is typically a short distance from the rear end of the vehicle. The distance between the rear of the vehicle and a target parking spot is sometimes too long for the locus lines to adequately aid the vehicle operator in easily guiding the vehicle towards the target.

Attempts have been made to increase the length of the locus lines in an attempt to direct the operator to the target. The systems typically change the display by superimposing a second locus line up to the target. However, such systems and methods that incorporate such method depend on an accurate prediction of the target.

There is also a drawback associated with having longer locus lines. If the locus lines are too long, the operator may be unduly confused by lines that cross through items on the display. This may mislead the operator's perception of the target, particularly when parking straight backward.

There is a need for a parking assist system that displays an overlay that extends a locus line closer to a target according to vehicle information including steering angle, wheel base size, and wheel radius.

### SUMMARY

The present invention is a parking assist method comprising the steps of, capturing a rear-facing image, displaying the rear-facing image, superimposing, by way of a camera module, at least one locus line on the displayed rear-facing image, sensing a steering wheel angle change on the vehicle, extracting vehicle wheel base data from memory in the camera module, calculating, in the camera module, at least one replacement locus line in response to the change in the steering wheel angle and vehicle wheel base data, and changing the display by superimposing the at least one replacement locus line on the displayed rear-facing image in place of the at least one locus line.

In another embodiment a camera module that senses a change in steering wheel angle, extracts vehicle wheel base data from memory, and calculates at least one locus line in response to the change in steering wheel angle, wherein the at least one locus line is superimposed on the rear-facing image.

### DESCRIPTION OF DRAWINGS

FIG. 1 is a block diagram of a parking assist system of the present invention;

FIG. 2 is a flow chart of a parking assist method of the present invention;

FIG. 3 is a screen shot image of a parking assist method of the present invention;

FIG. 4 is a screen shot image of a parking assist method of the present invention;

FIG. 5 is a screen shot image of a parking assist method of the present invention; and

FIG. 6 is a screen shot image of a parking assist method of the present invention.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DESCRIPTION OF INVENTION

While various aspects of the present invention are described with reference to a particular illustrative embodiment, the invention is not limited to such embodiments, and additional modifications, applications, and embodiments may be implemented without departing from the present invention. In the figures, like reference numbers will be used to illustrate the same components. Those skilled in the art will recognize that the various components set forth herein may be altered without varying from the scope of the inventive subject matter.

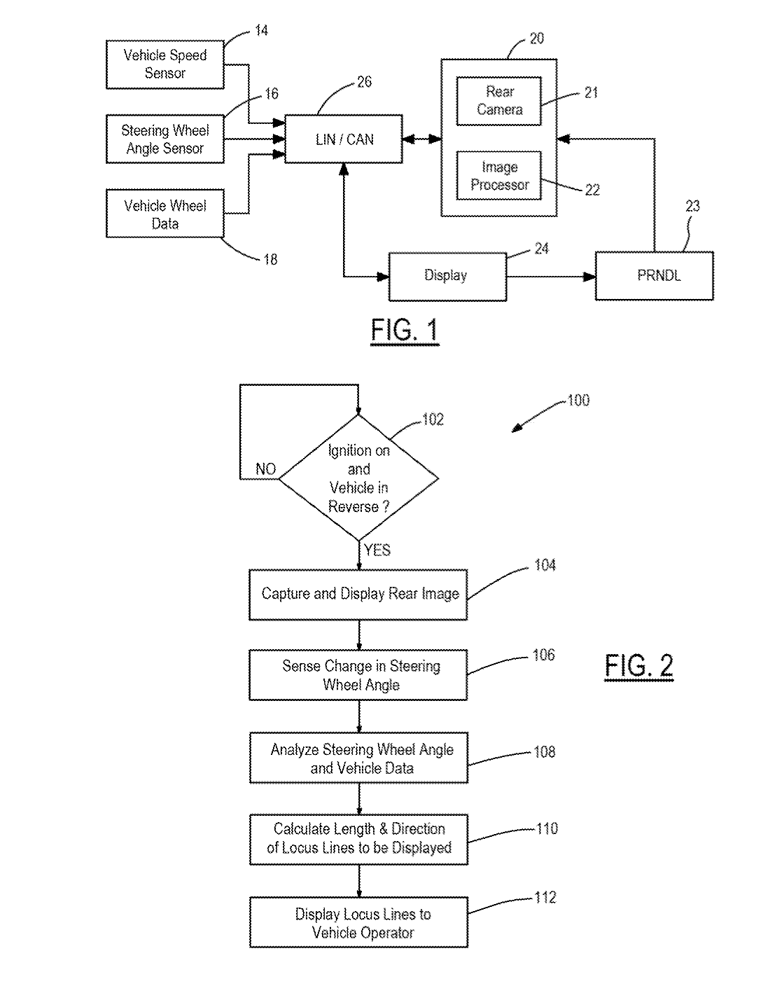

FIG. 1 shows a block diagram of a parking assist system 10 for a vehicle (not shown), such as an automobile. The parking assist system 10 has a camera module 20 that may control a variety of programs and processes that are related to the image processing, calculation and display of locus lines according to the present invention. The camera module 20 receives various inputs from a variety of vehicle sensors that include, but are not limited to, a vehicle speed sensor 14 and a steering wheel angle sensor 16. Vehicle wheel data 18 is also supplied to the camera module 20 and includes, but is not limited to, gear ratio, wheel base size, and wheel radius. Vehicle wheel data 18 may be stored in memory (not shown) in the camera module 20 to be called upon as needed. A camera 21 provides image data to the camera module 20. The camera 21 is typically mounted on the rear of the vehicle to provide rear-facing image data. The image data provided by the camera 21 is data that may be processed as by an image processor 22, and used in the camera module 20 to calculate and display locus lines according to the present invention. In FIG. 1, the camera 21 and image processor 22 are shown as integrated into the camera module 20. It should also be noted that in the alternative the devices 20, 21, 22 may be separate units in communication with each other.

A display 24 in the vehicle shows the camera output, image and locus lines, to a vehicle operator. The camera module 20 may also be coupled to a vehicle control network 26, such as an LIN or a CAN for communicating vehicle data and inputs 14, 16, 18 to the camera module 20. The camera module 20 also uses information about whether the vehicle is in park, reverse, neutral, drive, or low gear, also known as PRNDL 23. Typically, when the vehicle is in reverse, R, the camera 21 provides image data to the camera module 20, which is processed by the image processor 22 and shown on the display 24.

FIG. 2 shows a flow chart of a parking assist method 100 of the present invention. Upon start-up of the vehicle, for example an ignition on, and when the vehicle is in reverse 102, a rear-view image is captured and displayed 104 on the display. As a vehicle operator turns the steering wheel, the steering wheel angle sensor sends 106 steering wheel angle data to the controller. The camera and image processor analyze 108 the data coming from the steering wheel angle sensor, along with other vehicle data, including the gear ratio, wheel base size, wheel radius and vehicle speed data, and calculates 110 a proper size and direction for locus lines to be displayed 112 on the display.

The locus lines are dynamic in that their length and direction are determined in response to a change in the steering wheel angle and other vehicle data related to wheel base, radius, and gear radio. Each step of calculating locus lines depends on the turning radius and the current steering wheel angle of the vehicle, so the locus lines will change as the steering wheel angle is changed. As the operators turns the steering wheel, each step and direction the steering wheel moves is reflected in the locus line length and direction as displayed. The locus lines display a true path of the vehicle so that the vehicle operator gets a true sense of where the vehicle is headed as they turn the wheel and approach their desired destination.

As the steering wheel angle moves from a center position, not only the direction of the locus lines is adjusted but the length of the locus lines will also be adjusted accordingly. For example, as the steering wheel is turned away from center, the locus line length is typically increased. As the steering wheel is turned towards center, the locus lines are typically decreased in length. The locus lines have a maximum length at a steering wheel angle that is furthest from center and a minimum length at a steering wheel angle that is at center.

For each change in steering wheel angle, the camera module 20 recalculates and displays locus lines at the proper angle and length. At a maximum angle, either left or right of center, the locus lines extend to a maximum length dimension. The locus lines are providing the accurate projected vehicle path, and necessarily a path to the target only. The vehicle operator is given a true indication of where the vehicle is headed based on the steering wheel angle position and the vehicle wheel base information. The true vehicle path, as opposed to a vehicle path to a target, provides the vehicle operator with the ability to reach a desired location with ease, knowing for sure the direction the vehicle is headed by the locus lines displayed on the display.

The system and method of the present invention are directed to the actual path of the vehicle based on the steering wheel angle and the vehicle wheel base information. There is no need for identifying and tracking a target in the method of the present invention. Because the lines are adequately angled and displayed at an ideal length, the vehicle operator is able to easily identify the target, follow the actual vehicle path, and maintain a direction towards the target without the confusion of locus lines that interfere with, or are too short from, the desired target.

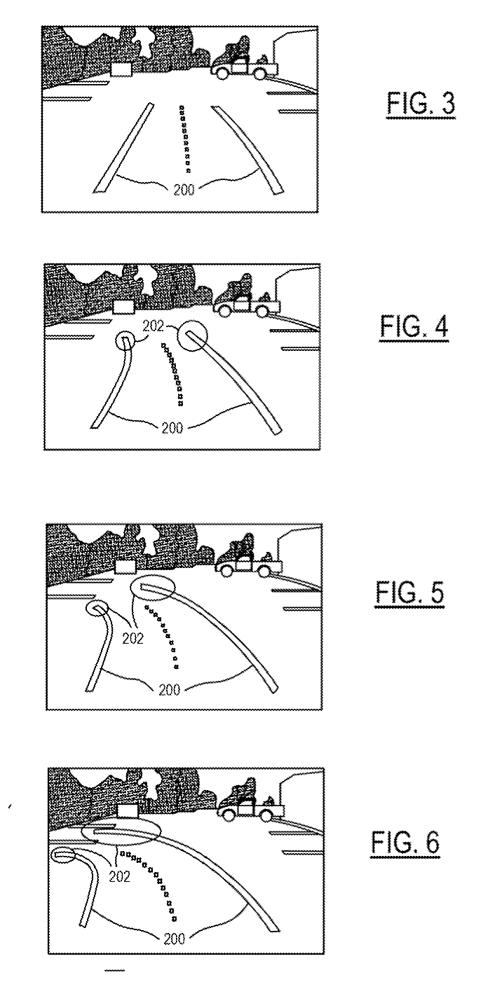

FIGS. 3 through 6 show locus lines 200 that are displayed to the vehicle operator according to the method of the present invention as the steering wheel is turned to guide a vehicle backwards into a parking spot. FIG. 3 shows the locus lines' angle and length when the steering wheel angle is at a center position. Referring now to FIG. 4, as the operator turns the steering wheel, the locus lines 200 are extended, as shown by the circled portion 202. It should be noted that in practice, the circled portion 202 is not visible to the vehicle operator and is merely shown for clarity purposes in FIGS. 4 through 6 as a reference in order to emphasize the extended portion of the locus lines that will be displayed. The locus line direction and length is determined not only by the current steering wheel position, as set by the vehicle operator, but also by incorporating data about the vehicle wheel base dimensions, wheel radius dimensions, turning radius, etc. This allows the locus lines displayed to be an accurate representation of the actual path the vehicle is following based on the current steering wheel angle. Should the operator maintain the steering wheel angle, the extended locus line indicates the true path the vehicle will follow. The more the vehicle operator turns the wheel, the more the dynamic locus lines stretch to show the vehicle's true path as shown in FIGS. 5 and 6.

By extending the lines according to the vehicle's true path, an operator is able to sec the projected path of the vehicle. This reduces the amount of subjective guesswork by the operator that is typically associated with determining the true path of the vehicle to a desired destination. Typical systems use a target and provide a path to the target. The operator must guess the true path of the vehicle as the steering wheel angle is adjusted on course to the target using the path shown to the target which is not the true path of the vehicle, but an estimated path based on recognition of target location information. The present invention does not use a target to determine the locus lines and instead displays the actual path of the vehicle to aid in guiding the operator towards the desired destination. The present invention provides the vehicle's true path based on current vehicle information so the operator can keep the target in sight but know at all times the actual path the vehicle is following.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. The equations may be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What is claimed is:

1. A parking assist method comprising the steps of:
capturing a rear-facing image;
displaying the rear-facing image;
superimposing, by way of a camera module, at least one locus line on the displayed rear-facing image;
sensing a steering wheel angle change on the vehicle;
extracting vehicle wheel base data from memory in the camera module;
calculating, in the camera module, at least one replacement locus line in response to the change in the steering wheel angle and vehicle wheel base data; and
changing the display by superimposing the at least one replacement locus line on the displayed rear-facing image in place of the at least one locus line.

2. The method as claimed in claim 1 wherein the step of extracting vehicle wheel base data includes data from the group consisting of: gear ratio, wheel base size, and wheel radius.

3. The method as claimed in claim 2 wherein the step of calculating at least one replacement locus line further comprises the steps of:
extending a length of the replacement locus line as the steering wheel angle moves away from a center position; and
decreasing a length of the replacement locus line as the steering wheel angle moves towards the center position.

4. The method as claimed in claim 3 wherein at least one replacement locus line further comprises two locus lines separated by a predetermined distance.

5. A parking assist system comprising:
a camera device for capturing a rear-facing image;
a display device for displaying the rear-facing image;
a camera module that senses a change in steering wheel angle, extracts vehicle wheel base data from memory, and calculates at least one locus line in response to the change in steering wheel angle, wherein the at least one locus line is superimposed on the rear-facing image.

6. The parking assist system as claimed in claim 5 wherein the wheel base data further comprises gear ratio, wheel base size and wheel radius.

7. The parking assist system as claimed in claim 6 further comprising:
the at least one locus line having an extended length for a steering wheel angle change that is away from a center position; and
the at least one locus line having a decreased length for a steering wheel angle change that is towards a center position.

8. The parking assist system as claimed in claim 6 wherein at least one locus line further comprises two lines separated by a predetermined distance.

9. A method for displaying park assist locus lines in a park assist system having a camera device, a display device and a steering wheel angle sensor, the method comprising the steps of:
capturing a rear-facing image;
displaying the rear-facing image;
sensing a current steering wheel angle;
calculating, in a camera module, a length and direction of the park assist locus lines to be displayed based on the current steering wheel angle and stored wheel dimension information; and
displaying the park assist locus lines on the display device according to the calculated length and direction.

10. The method as claimed in claim 9 wherein the step of calculating a length and direction of the park assist locus lines further comprises the step of extracting vehicle wheel dimension information from the group consisting of a gear ratio, a wheel base size, and a wheel radius.

11. The method as claimed in claim 10 wherein the step of calculating a length and direction of the park assist locus lines further comprises the steps of:
extending a length as the steering wheel angle moves away from a center position; and
decreasing a length as the steering wheel angle moves towards the center position.
